(19) United States
(12) Patent Application Publication
(10) Pub. No.: US 2026/0005288 A1
(43) Pub. Date: Jan. 1, 2026

(54) ELECTROCHEMICAL DEVICE AND ELECTRONIC DEVICE

(71) Applicant: Ningde Amperex Technology Limited, Ningde (CN)

(72) Inventors: Junfei LIU, Ningde (CN); Shaoyun ZHOU, Ningde (CN)

(73) Assignee: Ningde Amperex Technology Limited, Ningde (CN)

(21) Appl. No.: 19/320,103

(22) Filed: Sep. 5, 2025

Related U.S. Application Data
(63) Continuation of application No. PCT/CN2024/078234, filed on Feb. 23, 2024.

(30) Foreign Application Priority Data
Mar. 7, 2023 (WO) PCT/CN2023/080022

(51) Int. Cl. H01M 10/0525; H01M 4/02; H01M 4/1393; H01M 4/583; H01M 4/62; H01M 4/66; H01M 10/0567; H01M 10/0568; H01M 10/0569

(52) U.S. Cl. CPC H01M 10/0525; H01M 4/1393; H01M 4/583; H01M 4/622; H01M 4/625; H01M 4/662; H01M 10/0567; H01M 10/0568; H01M 10/0569; H01M 2004/027; H01M 2300/0042

(57) ABSTRACT

An electrochemical device includes a negative electrode and an electrolyte, where the negative electrode includes a negative electrode current collector and a negative electrode active material layer disposed on at least one surface of the negative electrode current collector. The negative electrode current collector contains chromium, wherein based on a mass of the negative electrode current collector, a mass percentage of chromium is from 0.001% to 0.5%. The electrolyte includes an oxalate-based compound, where based on a mass of the electrolyte, a mass percentage of the oxalate-based compound is from 0.01% to 5%; and the oxalate-based compound includes at least one of a compound of formula I, a compound of formula II, a compound of formula III, a compound of formula IV, or a compound of formula V.

### CROSS REFERENCE TO THE RELATED APPLICATIONS

The present application is a continuation under 35 U.S.C. § 120 of international patent application PCT/CN2024/078234 filed on Feb. 23, 2024, which claims priority to international application No. PCT/CN2023/080022, filed with the China National Intellectual Property Administration on Mar. 7, 2023 and entitled “ELECTROCHEMICAL DEVICE AND ELECTRONIC DEVICE”, which is incorporated herein by reference in its entirety.

### TECHNICAL FIELD

The present application relates to the field of energy storage, and specifically to an electrochemical device and an electronic device.

### BACKGROUND

Electrochemical devices (for example, lithium-ion batteries) possess advantages such as high energy density, stable operating voltage, low self-discharge rate, long cycle life, no memory effect, and environmental friendliness. These devices have been widely used in consumer electronics (including mobile phones, laptops, cameras, and other electronic products), electric vehicles, power tools, drones, intelligent robots, and large-scale energy storage fields and industries. However, with the rapid advancement of information and communication technology and the diversification of market demands, people have imposed more requirements and challenges on power sources for electronic products, such as thinner and lighter designs, more diverse shapes, higher volumetric and gravimetric energy densities, improved safety, and higher power output.

The positive electrode active material, negative electrode active material, and electrolyte contained in electrochemical devices are sensitive to moisture. Therefore, during the battery manufacturing process, it is necessary to maintain a low-humidity environment as much as possible, which significantly impacts the control of the manufacturing process, battery performance, and production costs.

In view of this, it is indeed necessary to provide an electrochemical device that can tolerate the humidity effects in the battery production environment.

### SUMMARY

The present application aims to address at least one of the issues existing in the related field to at least some extent by providing an electrochemical device and an electronic device.

According to one aspect of the present application, an electrochemical device is provided, the electrochemical device including a negative electrode and an electrolyte, where:
the negative electrode includes a negative electrode current collector and a negative electrode active material layer disposed on at least one surface of the negative electrode current collector, the negative electrode current collector containing chromium, where based on a mass of the negative electrode current collector, a mass percentage of chromium is from 0.001% to 0.5%;
the electrolyte includes an oxalate-based compound, where based on a mass of the electrolyte, a mass percentage of the oxalate-based compound is from 0.01% to 5%; and
the oxalate-based compound includes at least one of a compound of formula I, a compound of formula II, a compound of formula III, a compound of formula IV, or a compound of formula V:

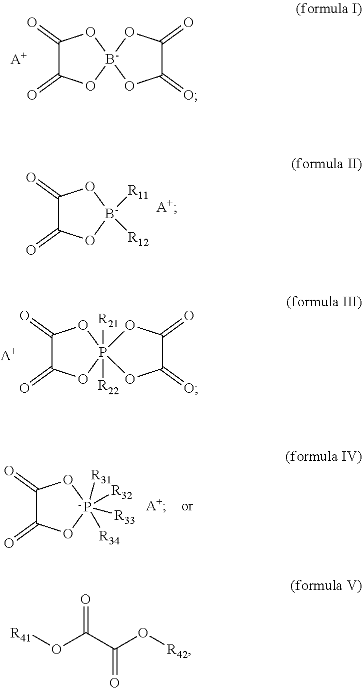

where:
each A⁺ is independently selected from Li⁺, Na⁺, K⁺, or Cs⁺;
R₁₁, R₁₂, R₂₁, R₂₂, R₃₁, R₃₂, R₃₃, and R₃₄ are each independently selected from halogen, unsubstituted or halogen-substituted C₁₋₄ alkyl, unsubstituted or halogen-substituted C₂₋₄ alkenyl, or unsubstituted or halogen-substituted C₂₋₄ alkynyl; and R₄₁ and R₄₂ are each independently selected from H, Li, Na, K, Cs, NH₄, unsubstituted or halogen-substituted C₁₋₄ alkyl, unsubstituted or fluorine-substituted C₂₋₄ alkenyl, or unsubstituted or fluorine-substituted C₂₋₄ alkynyl, where R₄₁ and R₄₂ may optionally bond with atoms to which they are attached to form a ring.

According to an embodiment of the present application, the compound of formula I includes at least one of the following compounds: lithium bis(oxalato) borate (LiBOB), sodium bis(oxalato) borate (NaBOB), cesium bis(oxalato) borate (CsBOB), or potassium bis(oxalato) borate (KBOB);
the compound of formula II includes at least one of the following compounds:

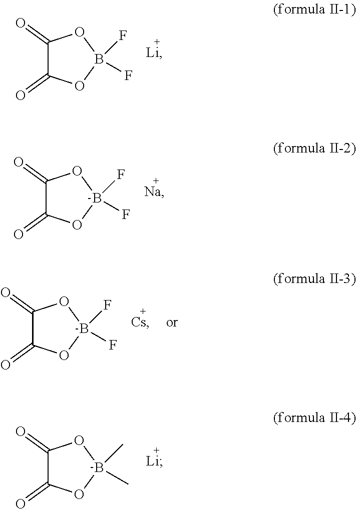

the compound of formula III includes at least one of the following compounds:

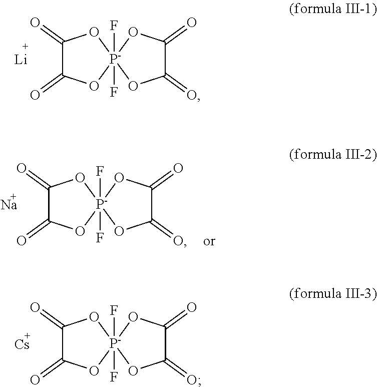

the compound of formula IV includes at least one of the following compounds:

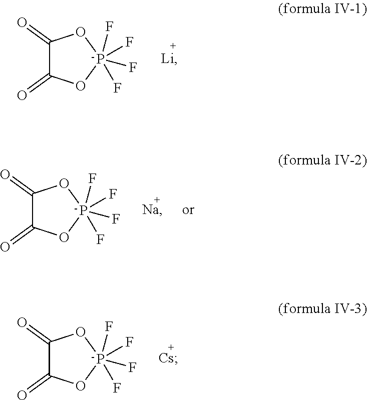

the compound of formula V includes at least one of the following compounds:
H₂C₂O₄, Li₂C₂O₄, Na₂C₂O₄, K₂C₂O₄, CS₂C₂O₄, NH₄C₂O₄, CH₃C₂O₄Li,

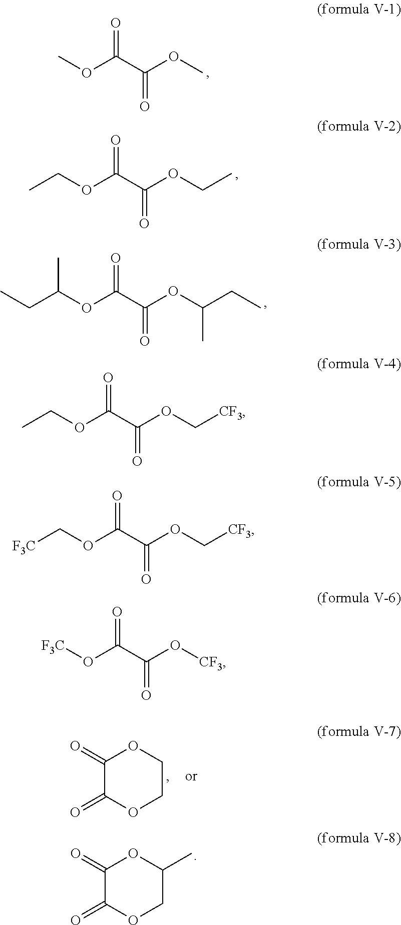

According to an embodiment of the present application, based on the mass of the electrolyte, the percentage of the oxalate-based compound is from 0.01% to 3%.

According to an embodiment of the present application, based on the mass of the electrolyte, the percentage of the oxalate-based compound is from 0.01% to 1%.

According to an embodiment of the present application, based on the mass of the negative electrode current collector, the percentage of chromium is from 0.001% to 0.1%.

According to an embodiment of the present application, based on the mass of the negative electrode current collector, the percentage of chromium is from 0.001% to 0.05%.

According to an embodiment of the present application, the negative electrode current collector is copper foil.

According to an embodiment of the present application, the electrolyte further includes a cyclic ester and a linear ester, the cyclic ester including at least one of ethylene carbonate (EC), propylene carbonate (PC), γ-butyrolactone (GBL), or fluoroethylene carbonate (FEC), and the linear ester including at least one of diethyl carbonate (DEC), ethyl methyl carbonate (EMC), dimethyl carbonate (DMC), ethyl acetate (EA), ethyl propionate (EP), or propyl propionate (PP), and based on the mass of the electrolyte, a mass percentage of the cyclic ester is S1%, and a mass percentage of the linear ester is S2%, where S1/S2 is in a range of 0.2 to 1.

According to an embodiment of the present application, S1 is in a range of 15 to 50.

According to an embodiment of the present application, the electrolyte further includes an additive, the additive being selected from at least one of 1,3-propane sultone (PS), ethylene sulfate (DTD), lithium difluorophosphate (LiPO₂F₂), or vinylene carbonate (VC), and based on the mass of the electrolyte, a mass percentage of the additive is from 0.01 wt % to 5 wt %.

According to another aspect of the present application, the present application provides an electronic device, including the electrochemical device according to the present application.

The present application provides an electrochemical device and an electronic device, which utilize an electrolyte containing an oxalate-based compound in combination with a negative electrode current collector containing chromium. On one hand, the oxalate-based compound can react with water in the electrolyte, consuming excess water and preventing the formation of hydrofluoric acid, thereby avoiding the destruction of the oxide protective layer formed by chromium. On the other hand, the oxalate ions produced by the hydrolysis of the oxalate-based compound can form a substance insoluble in the electrolyte with dissolved chromium ions, depositing on the surface of the negative electrode current collector to form a protective layer, thereby preventing the metal ions of the negative electrode current collector from dissolving and subsequently being reduced to elemental metal at the negative electrode. Due to the combined effect of these factors, the electrochemical device of the present application exhibits significantly reduced self-discharge.

Additional aspects and advantages of the present application will be partially described, shown, or elucidated through the implementation of the embodiments of the present application.

### DESCRIPTION OF EMBODIMENTS

To make the objectives, technical solutions, and advantages of the present application clearer, the present application is further described in detail below with reference to the accompanying drawings and embodiments. Apparently, the described embodiments are merely some but not all of the embodiments of the present application. All other embodiments obtained by persons skilled in the art based on the present application shall fall within the protection scope of the present application.

The embodiments of the present application will be described in detail below. The embodiments of the present application should not be construed as limiting the present application.

In the description of embodiments and claims, a list of items connected by the term “at least one of” may mean any combination of the listed items. For example, if items A and B are listed, the phrase “at least one of A or B” means only A; only B; or A and B. In another example, if items A, B, and C are listed, the phrase “at least one of A, B, or C” means only A, only B, or only C; A and B (exclusive of C); A and C (exclusive of B); B and C (exclusive of A); or all of A, B, and C. The item A may include a single element or a plurality of elements. Item B may include a single element or multiple elements. Item C may include a single element or multiple elements.

The term “alkyl group” is intended to be a straight-chain saturated hydrocarbon structure having 1 to 20 carbon atoms. The term “alkyl group” is also intended to be a branched or cyclic hydrocarbon structure having 3 to 20 carbon atoms. References to an alkyl group with a specific carbon number are intended to cover all geometric isomers with the specific carbon number. Therefore, for example, “butyl” is meant to include n-butyl, sec-butyl, isobutyl, tert-butyl, and cyclobutyl; and “propyl” includes n-propyl, isopropyl, and cyclopropyl. Examples of the alkyl group include, but are not limited to, a methyl group, an ethyl group, an n-propyl group, an isopropyl group, an cyclopropyl group, an n-butyl group, an isobutyl group, a sec-butyl group, a tert-butyl group, a cyclobutyl group, an n-pentyl group, an isopentyl group, a neopentyl group, a cyclopentyl group, a methylcyclopentyl group, an ethylcyclopentyl group, an n-hexyl group, an isohexyl group, a cyclohexyl group, an n-heptyl group, an octyl group, a cyclopropyl group, a cyclobutyl group, a norbornyl group, and the like.

The term “alkenyl group” refers to a straight-chain or branched monovalent unsaturated hydrocarbon group having at least one and usually 1, 2, or 3 carbon-carbon double bonds. Unless otherwise defined, the alkenyl typically contains 2 to 20 carbon atoms and includes, for example, —C₂₋₄ alkenyl, —C₂₋₆ alkenyl, and —C₂₋₁₀ alkenyl. Representative alkenyl groups include, for example, vinyl, n-propenyl, isopropenyl, n-but-2-enyl, but-3-enyl, n-hex-3-enyl, and the like.

The term “alkynyl group” refers to a straight-chain or branched monovalent unsaturated hydrocarbon group having at least one and usually 1, 2, or 3 carbon-carbon triple bonds. Unless otherwise defined, the alkynyl typically contains 2 to 20 carbon atoms and includes, for example, —C₂₋₄ alkynyl, —C₃₋₆ alkynyl, and —C₃₋₁₀ alkynyl. Representative alkynyl groups include, for example, ethynyl, prop-2-ynyl (n-propynyl), n-but-2-ynyl, and n-hex-3-ynyl.

The term “halogen” may be F, Cl, Br, or I.

The positive electrode active material, negative electrode active material, and electrolyte in electrochemical devices (for example, lithium-ion batteries) are sensitive to moisture. For example, in high-humidity environments, the negative electrode current collector (for example, copper foil) is prone to corrosion, which causes many adverse effects on the electrochemical device. Using a chromium-containing copper current collector can to some extent delay the oxidation of the copper current collector in air and the corrosion caused by the electrolyte, but the oxide protective layer formed by chromium can still be destroyed by hydrofluoric acid in the electrolyte, leading to copper dissolution and consequently increased self-discharge of the electrochemical device.

To address the above issues, the present application provides an electrochemical device that uses an electrolyte containing an oxalate-based compound in combination with a negative electrode current collector containing chromium. On one hand, the oxalate-based compound can react with water in the electrolyte, consuming excess water and preventing the formation of hydrofluoric acid, thereby avoiding the destruction of the oxide protective layer formed by chromium. On the other hand, the oxalate ions produced by the hydrolysis of the oxalate-based compound can form a substance insoluble in the electrolyte with dissolved chromium ions, depositing on the surface of the negative electrode current collector to form a protective layer, thereby preventing the metal ions of the negative electrode current collector from dissolving and subsequently being reduced to elemental metal at the negative electrode. Due to the combined effect of these factors, the electrochemical device of the present application exhibits significantly reduced self-discharge.

### Electrolyte

The electrolyte in the electrochemical device of the present application includes an oxalate-based compound, where based on a mass of the electrolyte, a mass percentage of the oxalate-based compound is from 0.01% to 5%, and the oxalate-based compound includes at least one of a compound of formula I, a compound of formula II, a compound of formula III, a compound of formula IV, or a compound of formula V:

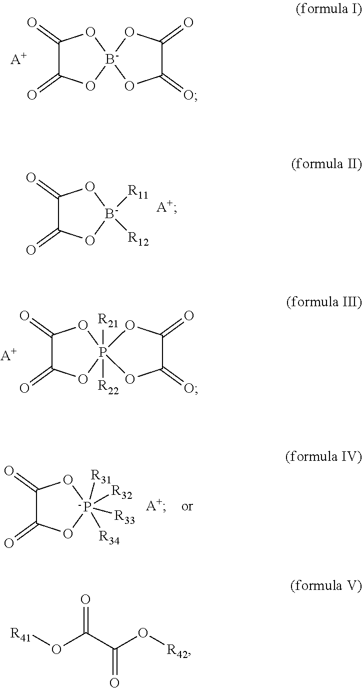

where:
each A⁺ is independently selected from Li⁺, Na⁺, K⁺, or Cs⁺;
R₁, R₁₂, R₂₁, R₂₂, R₃₁, R₃₂, R₃₃, and R₃₄ are each independently selected from halogen, unsubstituted or halogen-substituted C₁₋₄ alkyl, unsubstituted or halogen-substituted C₂₋₄ alkenyl, or unsubstituted or halogen-substituted C₂₋₄ alkynyl; and
R₄₁ and R₄₂ are each independently selected from H, Li, Na, K, Cs, NH₄, unsubstituted or halogen-substituted C₁₋₄ alkyl, unsubstituted or fluorine-substituted C₂-4 alkenyl, or unsubstituted or fluorine-substituted C₂₋₄ alkynyl, where R₄₁ and R₄₂ may optionally bond with the atoms to which R₄₁ and R₄₂ are attached to form a ring.

In some embodiments, the compound of formula I includes at least one of the following compounds: lithium bis(oxalato) borate (LiBOB), sodium bis(oxalato) borate (NaBOB), cesium bis(oxalato) borate (CsBOB), or potassium bis(oxalato) borate (KBOB).

In some embodiments, the compound of formula II includes at least one of the following compounds:

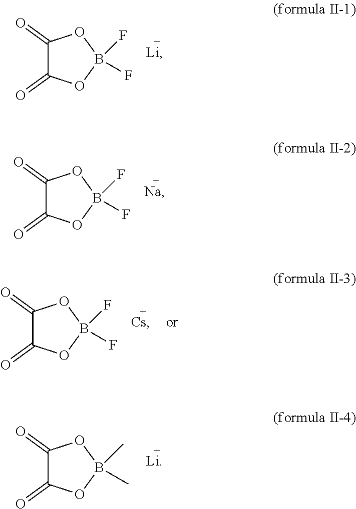

In some embodiments, the compound of formula III includes at least one of the following compounds:

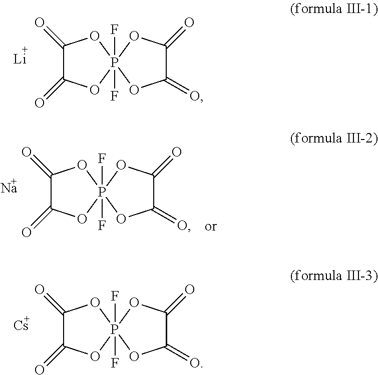

In some embodiments, the compound of formula IV includes at least one of the following compounds:

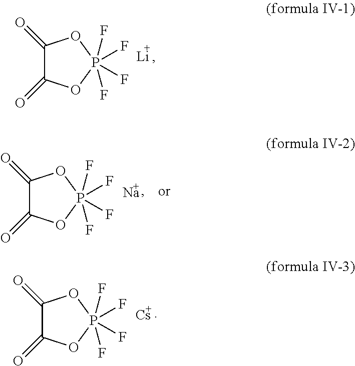

In some embodiments, the compound of formula V includes at least one of the following compounds:
H₂C₂O₄, Li₂C₂O₄, Na₂C₂O₄, K₂C₂O₄, CS₂C₂O₄, NH₄C₂O₄, CH₃C₂O₄Li,

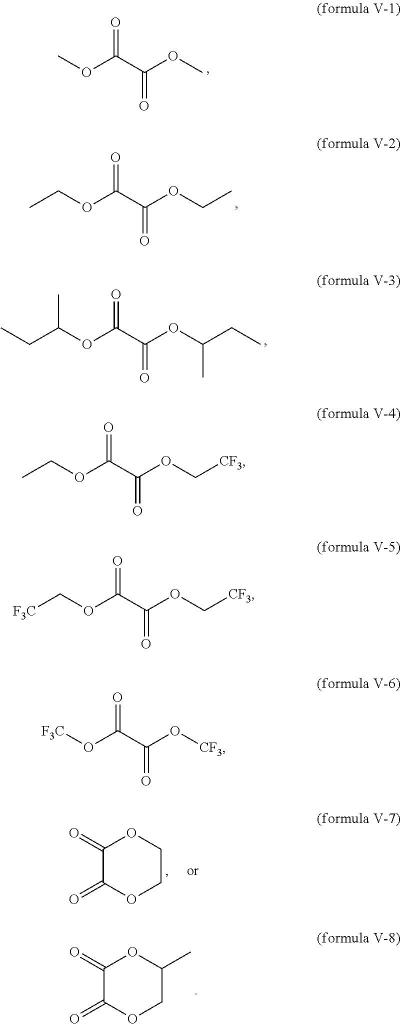

In some embodiments, based on the mass of the electrolyte, the percentage of the oxalate-based compound is from 0.01% to 3%. In some embodiments, based on the mass of the electrolyte, the percentage of the oxalate-based compound is from 0.01% to 1%. In some embodiments, based on the mass of the electrolyte, the percentage of the oxalate-based compound is from 0.1% to 0.5%. In some embodiments, based on the mass of the electrolyte, the percentage of the oxalate-based compound is 0.01%, 0.05%, 0.1%, 0.5%, 1%, 2%, 3%, 4%, 5%, or within a range formed by any two of the above values. When the percentage of the oxalate-based compound in the electrolyte is within the above range, it contributes to further reducing the self-discharge of the electrochemical device.

In some embodiments, the electrolyte further includes a cyclic ester and a linear ester, the cyclic ester including at least one of ethylene carbonate (EC), propylene carbonate (PC), γ-butyrolactone (GBL), or fluoroethylene carbonate (FEC), and the linear ester including at least one of diethyl carbonate (DEC), ethyl methyl carbonate (EMC), dimethyl carbonate (DMC), ethyl acetate (EA), ethyl propionate (EP), or propyl propionate (PP), and based on the mass of the electrolyte, a mass percentage of the cyclic ester is S1%, and a mass percentage of the linear ester is S2%, where S1/S2 is in the range of 0.2 to 1.

In some embodiments, S1/S2 is 0.2, 0.3, 0.4, 0.5, 0.6, 0.7, 0.8, 0.9, 1, or within a range formed by any two of the above values.

In some embodiments, S1 is in a range of 15 to 50. In some embodiments, S1 is 15, 30, 40, 50, or within a range formed by any two of the above values.

In some embodiments, S2 is in a range of 15 to 75. In some embodiments, S2 is 15, 25, 35, 45, 55, 65, 75, or within a range formed by any two of the above values.

When the electrolyte contains the cyclic ester and linear ester in the above percentage ranges, the mixed solvent forms a suitable coordination relationship with the electrolyte salt (for example, LiPF₆), existing in a form of ion clusters, which weakens the redox reaction activity of individual solvents, helps reduce chemical self-discharge caused by side reactions, and maintains stable self-discharge evaluation parameter K values; at the same time, it ensures sufficient dissociation of the electrolyte salt and a relatively low overall viscosity of the electrolyte, enhancing the electrolyte conductivity, thereby improving the low-temperature discharge performance of the battery.

In some embodiments, the electrolyte further includes an additive, the additive being selected from at least one of 1,3-propane sultone (PS), ethylene sulfate (DTD), lithium difluorophosphate (LiPO₂F₂), or vinylene carbonate (VC), where based on the mass of the electrolyte, a mass percentage of the additive is from 0.01 wt % to 5 wt %.

In some embodiments, based on the mass of the electrolyte, the percentage of the additive is from 0.05 wt % to 3 wt %. In some embodiments, based on the mass of the electrolyte, the percentage of the additive is from 0.1 wt % to 1 wt %. In some embodiments, based on the mass of the electrolyte, the percentage of the additive is 0.01 wt %, 0.05 wt %, 0.1 wt %, 0.5 wt %, 1 wt %, 2 wt %, 3 wt %, 4 wt %, 5 wt %, or within a range formed by any two of the above values.

The addition of additives not only further reduces the self-discharge of the electrochemical device but also significantly mitigates the gas generation issue during storage caused by the low oxidation potential of the oxalate-based compound. This is because the additives can form a protective layer on the electrode surface, reducing the occurrence of side reactions and thereby reducing chemical self-discharge. Additionally, the additives can reduce the gas generation caused by oxidative decomposition of the oxalate-based compound at the positive electrode, improving the high-temperature storage performance of the electrochemical device.

The electrolyte used in the present application includes LiPF₆, and in some embodiments, the concentration of LiPF₆ is in a range of 0.8 mol/L to 3 mol/L, 0.8 mol/L to 2.5 mol/L, 0.8 mol/L to 2 mol/L, or 1 mol/L to 2 mol/L. In some embodiments, a concentration of the lithium salt is about 1 mol/L, about 1.15 mol/L, about 1.2 mol/L, about 1.5 mol/L, about 2 mol/L, or about 2.5 mol/L.

Solvents used in the electrolyte of the embodiments of the present application include, but are not limited to, cyclic carbonates, linear carbonates, cyclic carboxylic esters, linear carboxylic esters, cyclic ethers, linear ethers, phosphorus-containing organic solvents, sulfur-containing organic solvents, and aromatic fluorine-containing solvents.

In some embodiments, cyclic carbonates include, but are not limited to, ethylene carbonate (EC), propylene carbonate (PC), and butylene carbonate. In some embodiments, cyclic carbonates have 3 to 6 carbon atoms.

In some embodiments, linear carbonates include, but are not limited to, linear carbonates such as methyl n-propyl carbonate, ethyl n-propyl carbonate, and di-n-propyl carbonate, and fluorine-substituted linear carbonates such as bis(fluoromethyl) carbonate, bis(difluoromethyl) carbonate, bis(trifluoromethyl) carbonate, bis(2-fluoroethyl) carbonate, bis(2,2-difluoroethyl) carbonate, bis(2,2,2-trifluoroethyl) carbonate, 2-fluoroethyl methyl carbonate, 2,2-difluoroethyl methyl carbonate, and 2,2,2-trifluoroethyl methyl carbonate.

In some embodiments, cyclic carboxylic esters include, but are not limited to, γ-valerolactone. In some embodiments, some hydrogen atoms of the cyclic carboxylic ester may be substituted with fluorine.

In some embodiments, linear carboxylic esters include, but are not limited to, methyl acetate, propyl acetate, isopropyl acetate, butyl acetate, sec-butyl acetate, isobutyl acetate, tert-butyl acetate, methyl propionate, isopropyl propionate, methyl butyrate, ethyl butyrate, propyl butyrate, methyl isobutyrate, ethyl isobutyrate, methyl valerate, ethyl valerate, methyl pivalate, and ethyl pivalate. In some embodiments, some hydrogen atoms of the linear carboxylic ester may be substituted with fluorine. In some embodiments, the fluorine-substituted linear carboxylate includes but is not limited to methyl trifluoroacetate, ethyl trifluoroacetate, propyl trifluoroacetate, butyl trifluoroacetate, and 2,2,2-trifluoroethyl trifluoroacetate.

In some embodiments, the cyclic ether includes but is not limited to tetrahydrofuran, 2-methyltetrahydrofuran, 1,3-dioxolane, 2-methyl 1,3-dioxolane, 4-methyl 1,3-dioxolane, 1,3-dioxane, 1,4-dioxane, and dimethoxypropane.

In some embodiments, the linear ether includes but is not limited to dimethoxymethane, 1,1-dimethoxyethane, 1,2-dimethoxyethane, diethoxymethane, 1,1-diethoxyethane, 1,2-diethoxyethane, ethoxymethoxymethane, 1,1-ethoxymethoxyethane, and 1,2-ethoxymethoxyethane.

In some embodiments, phosphorus-containing organic solvents include, but are not limited to, trimethyl phosphate, triethyl phosphate, dimethyl ethyl phosphate, methyl diethyl phosphate, ethylene methyl phosphate, ethylene ethyl phosphate, triphenyl phosphate, trimethyl phosphite, triethyl phosphite, triphenyl phosphite, tris(2,2,2-trifluoroethyl) phosphate, and tris(2,2,3,3,3-pentafluoropropyl) phosphate.

In some embodiments, the sulfur-containing organic solvent includes but is not limited to sulfolane, 2-methylsulfolane, 3-methylsulfolane, dimethyl sulfone, diethyl sulfone, ethyl methyl sulfone, methyl propyl sulfone, dimethyl sulfoxide, methyl methanesulfonate, ethyl methanesulfonate, methyl ethanesulfonate, ethyl ethanesulfonate, dimethyl sulfate, diethyl sulfate, and dibutyl sulfate. In some embodiments, some hydrogen atoms in the sulfur-containing organic solvent may be replaced with fluorine.

In some embodiments, the aromatic fluorine-containing solvent includes but is not limited to fluorobenzene, difluorobenzene, trifluorobenzene, tetrafluorobenzene, pentafluorobenzene, hexafluorobenzene, and trifluoromethylbenzene.

In some embodiments, the solvent used in the electrolyte of the present application includes one or more of the foregoing solvents. In some embodiments, the solvent used in the electrolyte of the present application includes cyclic carbonate, linear carbonate, cyclic carboxylate, linear carboxylate, and a combination thereof. In some embodiments, the solvent used in the electrolyte of the present application includes an organic solvent selected from a group consisting of the following substances: ethylene carbonate, propylene carbonate, diethyl carbonate, ethyl propionate, propyl propionate, n-propyl acetate, ethyl acetate, and a combination thereof. In some embodiments, the solvent used in the electrolyte of the present application includes ethylene carbonate, propylene carbonate, diethyl carbonate, ethyl propionate, propyl propionate, γ-butyrolactone, or a combination thereof.

### Negative Electrode

The negative electrode in the electrochemical device of the present application includes a negative electrode current collector and a negative electrode active material layer disposed on at least one surface of the negative electrode current collector, the negative electrode current collector containing chromium, and based on the mass of the negative electrode current collector, the percentage of chromium being from 0.001% to 0.5%. In some embodiments, based on the mass of the negative electrode current collector, the percentage of chromium is from 0.001% to 0.1%. In some embodiments, based on the mass of the negative electrode current collector, the percentage of chromium is from 0.001% to 0.05%. In some embodiments, based on the mass of the negative electrode current collector, the percentage of chromium is 0.001%, 0.005%, 0.01%, 0.05%, 0.1%, 0.2%, 0.3%, 0.4%, 0.5%, or within a range formed by any two of the above values.

In some embodiments, the negative electrode current collector is copper foil. The copper foil containing chromium may be denoted as Cu(Cr). Cu(Cr) is an alloy with copper as the main component and containing a small amount of Cr, where Cr may form a protective film on the surface of the current collector or may be embedded in Cu in a crystal phase. Cu(Cr) may contain components other than Cu and Cr, or may substantially contain only Cu and Cr.

In some embodiments, the negative electrode active material layer includes a negative electrode active material, and the specific type of the negative electrode active material is not particularly limited and can be selected according to needs. Specifically, the negative electrode active material is selected from one or more of natural graphite, artificial graphite, mesocarbon microbeads (MCMB), hard carbon, soft carbon, silicon, silicon-carbon composite, Li—Sn alloy, Li—Sn—O alloy, Sn, SnO, SnO₂, lithiated TiO₂—Li₄TisO₁₂ with a spinel structure, Li metal, or Li—Al alloy. The silicon-carbon composite refers to a negative electrode active material containing at least about 5 wt % silicon by weight.

In some embodiments, the negative electrode active material layer further includes a negative electrode binder. In some embodiments, the negative electrode binder includes one or more of styrene-butadiene rubber, fluororubber, and ethylene propylene diene.

In some embodiments, the negative electrode active material layer further includes a negative electrode conductive agent. In some embodiments, the negative electrode conductive agent includes one or more of conductive metal materials and conductive polymers. In some embodiments, the negative electrode conductive agent includes one or more of carbon materials. In some embodiments, carbon materials include, but are not limited to, graphite, carbon black, acetylene black, and Ketjen black.

In some embodiments, a negative electrode active material layer is present on one surface of the negative electrode current collector. In some embodiments, negative electrode active material layers are present on both surfaces of the negative electrode current collector. In some embodiments, at least one surface of the negative electrode current collector includes a region where no negative electrode active material layer is disposed, also referred to as a bare foil region.

### Positive Electrode

The positive electrode includes a positive electrode current collector and a positive electrode active material disposed on the positive electrode current collector. The specific types of the positive electrode active material are not subject to specific restrictions, and can be selected according to requirements.

In some embodiments, the positive electrode active material includes a positive electrode material capable of absorbing and releasing lithium (Li). Examples of the positive electrode material capable of absorbing/releasing lithium (Li) may include lithium cobalt oxide, lithium nickel cobalt manganate, lithium nickel cobalt aluminate, lithium manganate, lithium manganese iron phosphate, lithium vanadium phosphate, lithium vanadyl phosphate, lithium iron phosphate, lithium titanate, and lithium-rich manganese-based materials.

Specifically, the chemical formula of lithium cobalt oxide may be as shown in formula 1:

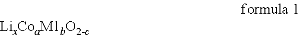

where M1 is selected from at least one element of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), yttrium (Y), lanthanum (La), zirconium (Zr), silicon (Si), fluorine (F), or sulfur(S), and the values of x, a, b, and c are respectively in the following ranges: 0.8≤x≤1.2, 0.8≤a≤1, 0≤b≤0.2, and −0.1≤c≤0.2.

The chemical formula of lithium nickel cobalt manganese oxide or lithium nickel cobalt aluminum oxide may be as shown in formula 2:

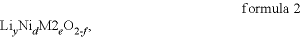

where M2 is selected from at least one element of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), zirconium (Zr), silicon (Si), fluorine (F), or sulfur(S), and the values of y, d, e, and f are respectively in the following ranges: 0.8≤y≤ 1.2, 0.3≤d≤0.98, 0.02≤e≤0.7, and −0.1≤f≤0.2.

The chemical formula of lithium manganese oxide may be as shown in formula 3:

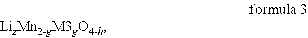

where M3 is selected from at least one element of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), niobium (Nb), tantalum (Ta), or tungsten (W), and the values of z, g, and h are respectively in the following ranges: 0.8≤z≤1.2, 0≤g≤1.0, and −0.2≤h≤ 0.2.

In some embodiments, the positive electrode active material layer may have a coating on its surface or may be mixed with another compound having a coating. The coating may include at least one compound of a coating element selected from oxides of the coating element, hydroxides of the coating element, hydroxyl oxides of the coating element, oxycarbonate (oxycarbonate) of the coating element, and hydroxycarbonate (hydroxycarbonate) of the coating element. The compound used for the coating may be amorphous or crystalline. The coating element contained in the coating may include Mg, Al, Co, K, Na, Ca, Si, Ti, V, Sn, Ge, Ga, B, As, Zr, F, or a mixture thereof. The coating may be applied by using any method, provided that the method does not have adverse impact on performance of the positive electrode active material. For example, the method may include any coating method well known to a person of ordinary skill in the art, such as spraying or dipping.

In some embodiments, the positive electrode active material layer further includes a binder and optionally further includes a positive electrode conductive material.

The binder can enhance the bonding between particles of the positive electrode active material and also enhance the bonding between the positive electrode active material and the current collector. Non-limiting examples of the binder include polyvinyl alcohol, hydroxypropyl cellulose, diacetyl cellulose, polyvinyl chloride, carboxylated polyvinyl chloride, polyvinyl fluoride, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, nylon, and the like.

The positive electrode active material layer includes a positive electrode conductive material, thereby imparting conductivity to the electrode. The positive electrode conductive material may include any conductive material, provided that the conductive material does not cause a chemical change. Non-limiting examples of the positive electrode conductive material include carbon-based materials (for example, natural graphite, artificial graphite, carbon black, acetylene black, Ketjen black, carbon fiber, and the like), metal-based materials (for example, metal powder, metal fiber, and the like, including, for example, copper, nickel, aluminum, silver, and the like), conductive polymers (for example, polyphenylene derivatives), and mixtures thereof.

The positive electrode current collector used in the electrochemical device according to the present application may be aluminum (Al), but is not limited thereto.

### Separator

In some embodiments, the electrochemical device of the present application includes a separator disposed between the positive electrode and the negative electrode to prevent a short circuit due to contact between the two electrodes while allowing lithium ions to pass through.

The separator used in the electrochemical device according to the present application is not particularly limited to any material or shape, and may be based on any technology disclosed in the prior art. In some embodiments, the separator includes a polymer (for example, synthetic resin) or an inorganic material (for example, ceramic) formed from a material stable to the electrolyte of the present application. In some embodiments, the separator includes a porous film made of the polymer or the inorganic material. In some embodiments, the separator includes a laminated film formed by laminating two or more porous films. In some embodiments, the polymer includes, but is not limited to, polytetrafluoroethylene, polypropylene, and polyethylene.

In some embodiments, the separator includes the above-mentioned porous film (base material layer) and a polymer compound layer disposed on one or both surfaces of the base material layer, which can enhance the adhesion of the separator to the positive and negative electrodes, suppress skewing during winding of the electrode assembly, thereby suppressing the decomposition reaction of the electrolyte and preventing leakage of the electrolyte impregnated in the base material layer. By using such a separator, the resistance of the electrochemical device does not significantly increase even under repeated charging/discharging, thereby suppressing the swelling of the electrochemical device.

In some embodiments, the polymer compound layer includes, but is not limited to, polyvinylidene fluoride. Polyvinylidene fluoride has excellent physical strength and electrochemical stability. The polymer compound layer can be formed by the following method: after preparing a solution in which the polymer material is dissolved, the base material layer is coated with the solution or the base material layer is immersed in the solution, and then dried.

### Applications

The electrochemical device according to the present application includes any device in which electrochemical reactions take place. Specific examples of the device include all kinds of primary batteries and secondary batteries. Especially, the electrochemical device is a lithium secondary battery, including a lithium metal secondary battery, a lithium-ion secondary battery, a lithium polymer secondary battery, or a lithium-ion polymer secondary battery.

The use of the electrochemical device of the present application is not particularly limited and can be used for any purpose known in the prior art. In one embodiment, the electrochemical device of the present application can be used for, but is not limited to, laptops, pen-input computers, mobile computers, e-book players, portable phones, portable fax machines, portable copiers, portable printers, head-mounted stereo headphones, video recorders, LCD TVs, handheld cleaners, portable CD players, mini discs, transceivers, electronic notebooks, calculators, memory cards, portable recorders, radios, backup power supplies, motors, automobiles, motorcycles, assisted bicycles, bicycles, lighting fixtures, toys, gaming consoles, clocks, power tools, flashlights, cameras, large household batteries, and lithium-ion capacitors.

The following takes a lithium-ion battery as an example and describes the preparation of the lithium-ion battery in conjunction with specific embodiments. Those skilled in the art will understand that the preparation methods described in the present application are only examples, and any other suitable preparation methods are within the scope of the present application.

### EXAMPLES

The following describes the performance evaluation of examples and comparative examples of lithium-ion batteries according to the present application.

### I. Preparation of Lithium-Ion Battery

### 1. Preparation of Negative Electrode

The negative electrode current collector Cu(Cr) involved in the examples and comparative examples is substantially a copper foil containing chromium, but the Cu(Cr) that can be used as a current collector is not limited to containing only Cu and Cr. The Cr percentage in Cu(Cr) can be controlled by any conventional method in the art, for example, by adjusting temperature, current density, and chromium plating solution concentration for chromium electroplating.

The negative electrode active material artificial graphite, conductive agent Super P, sodium carboxymethyl cellulose (CMC), and binder styrene-butadiene rubber (SBR) were mixed at a weight ratio of 96.4:1.5:0.5:1.6, deionized water was added, and the mixture was stirred uniformly to obtain a negative electrode slurry with a solid content of 54 wt %. The negative electrode slurry was uniformly applied on both surfaces of an 8 μm thick Cu(Cr) foil to form a negative electrode material layer, dried at 85° C., and then subjected to cold pressing, die-cutting, slitting, and winding, followed by drying under vacuum at 120° C. for 12 hours to obtain the negative electrode. The thickness of the single-sided negative electrode material layer was 52 μm.

### 2. Preparation of Positive Electrode

The positive electrode active material LiCoO₂, conductive agent conductive carbon black (Super-P), and polyvinylidene fluoride were mixed with N-methylpyrrolidone (NMP) at a mass ratio of 97:1.4:1.6, and stirred uniformly to obtain a positive electrode slurry with a solid content of 72 wt %. The positive electrode slurry was applied on both surfaces of a 10 μm thick aluminum foil to form a positive electrode material layer, dried at 85° C., and then subjected to cold pressing, die-cutting, slitting, and tab welding, followed by drying under vacuum at 85° C. for 4 hours to obtain the positive electrode. The thickness of the single-sided positive electrode material layer was 35.6 μm.

### 3. Preparation of Electrolyte

The preparation process for the electrolyte in Comparative Examples 1-1 to 1-4, Examples 1-1 to 1-20, and Examples 3-1 to 3-10 is as follows:

In a dry argon atmosphere, based on the total mass of the electrolyte, 20% EC, 25% PC, 20% DEC, and 20% EMC were mixed by mass ratio, dissolved, and thoroughly stirred, then additives were added according to the percentage and type required in the tables, stirring was continued, and finally the corresponding percentage of lithium salt LiPF₆ was added (to make the total percentage of the electrolyte components sum to 100%), and mixed uniformly to obtain the electrolyte.

The preparation process for the electrolyte in Examples 2-1 to 2-11 is as follows:

In a dry argon atmosphere, based on the total mass of the electrolyte, the solvents were mixed according to the percentages specified in the tables, then the additive II-1 of 0.10% from Example 1-6 was added, and finally the corresponding percentage of lithium salt LiPF₆ was added (to make the total percentage of the electrolyte components sum to 100%), and mixed uniformly to obtain the electrolyte.

The abbreviations and corresponding compound names of the components used in the electrolyte are shown in the table below:

| Abbreviation | Compound | Abbreviation | Compound |
|---|---|---|---|
| EC | Ethylene carbonate | PC | Propylene carbonate |
| DEC | Diethyl carbonate | EMC | Ethyl methyl carbonate |
| PP | Propyl propionate | EP | Ethyl propionate |
| GBL | γ-butyrolactone | FEC | Fluoroethylene |
| | | | carbonate |
| DMC | Dimethyl carbonate | DTD | Ethylene sulfate |
| PS | 1,3-Propane sultone | VC | Vinylene carbonate |
| LiBOB | Lithium | NaBOB | Sodium |
| | bis(oxalato)borate | | bis(oxalato)borate |
| KBOB | Potassium | CsBOB | Cesium |
| | bis(oxalato)borate | | bis(oxalato)borate |

### 4. Preparation of Separator

A 7 μm thick polyethylene (PE) film was selected, and both surfaces were coated with PVDF slurry and dried. Then, one surface was further coated with a slurry of inorganic particles (a mass ratio of flaky boehmite to Al₂O₃ of 70:30) and dried. The total thickness of the polyethylene film and the coating was 12 μm, obtaining the separator. The single-layer thickness of the PVDF slurry layer was 1.25 μm, and the thickness of the inorganic particle slurry layer was 2.5 μm.

### 5. Preparation of Lithium-Ion Battery

The obtained positive electrode, separator, and negative electrode were wound in sequence, placed in an outer packaging foil, leaving an injection port. The electrolyte was injected through the injection port, sealed, and then subjected to formation (charged at 0.02 C constant current to 3.3V, then at 0.1 C constant current to 3.8V) and capacity processes to obtain a lithium-ion battery (approximately 9.1 mm thick, 49 mm wide, and 74 mm long). The inorganic particle slurry layer faced the positive electrode.

### II. Testing Methods

### 1. Testing Method for Chromium Percentage in Negative Electrode Current Collector

The Cr percentage in Cu(Cr) was determined by inductively coupled plasma (ICP) testing.

### 2. Self-Discharge Testing Method for Lithium-Ion Battery

The lithium-ion battery was placed in a 25° C. constant temperature chamber and allowed to stand for 30 minutes to reach a constant temperature. The lithium-ion battery was then charged at 0.5 C constant current to 4.2V, charged at 4.2V constant voltage until the current reached 0.025 C, allowed to stand for 5 minutes, discharged at 0.5 C constant current to 3.0V, allowed to stand for 5 minutes, and then charged at 0.5 C constant current for 60 minutes. The open-circuit voltage OCV1 (V) of the lithium-ion battery was recorded at this point. The battery was then allowed to stand at 25° C. for 48±0.5 hours, and the open-circuit voltage OCV2 (V) was tested. The self-discharge evaluation parameter K (mV/h) of the lithium-ion battery was calculated using the following formula:

$$K = 1000 \times ( OCV 1 - OCV 2 ) / 48.$$

### 3. High-Temperature Storage Performance Testing Method for Lithium-Ion Battery

The lithium-ion battery was placed in a 25° C. constant temperature chamber and allowed to stand for 30 minutes to reach a constant temperature. The lithium-ion battery was then charged at 0.5 C constant current to 4.2V, charged at 4.2V constant voltage until the current reached 0.025 C, and the initial thickness H0 of the lithium-ion battery was tested. After storing the lithium-ion battery in an 80° C. high-temperature furnace for 24 hours, the thickness H1 of the lithium-ion battery was recorded. The storage thickness expansion rate of the lithium-ion battery was calculated using the following formula:

$$Storage thickness expansion rate = ( H 1 - H 0 ) / H 0 \times 100 \% .$$

### 4. Low-Temperature Discharge Performance Testing Method for Lithium-Ion Battery

The lithium-ion battery was placed in a temperature-adjustable high-low temperature chamber, with the temperature initially set to 25° C., and allowed to stand for 60 minutes. The battery was then charged at 0.5 C constant current to 4.2V, charged at 4.2V constant voltage until the current reached 0.025 C, allowed to stand for 10 minutes, and then discharged at 0.5 C constant current to 3.0V, with the discharge capacity recorded as DO. At 25° C., the battery was again charged at 0.5 C constant current to 4.2V, charged at 4.2V constant voltage until the current reached 0.025 C, the temperature was adjusted to −10° C., allowed to stand for 60 minutes, and then discharged at 0.5 C constant current to 3.0V, obtaining the discharge capacity D1. The low-temperature discharge capacity retention rate D of the lithium-ion battery was calculated using the following formula:

$$D = D 1 / D 0 \times 100 \% .$$

### III. Test Results

Table 1 shows the effects of chromium percentage in the negative electrode current collector and the oxalate-based compound and its percentage in the electrolyte on the self-discharge of the lithium-ion battery.

TABLE 1

| | | | Chromium | |
|---|---|---|---|---|
| | | | percentage in | |
| | Oxalate-based compound | | negative | |
| | Structural | | electrode | K |
| | formula | Percentage | current collector | (mV/h) |
| Comparative | — | — | — | 0.0958 |
| Example 1-1 | | | | |
| Comparative | — | — | 0.018% | 0.0950 |
| Example 1-2 | | | | |
| Comparative | Formula II-1 | 0.10% | — | 0.0947 |
| Example 1-3 | | | | |
| Comparative | — | — | 0.55% | 0.0955 |
| Example 1-4 | | | | |
| Example 1-1 | LiBOB | 0.10% | 0.018% | 0.0456 |
| Example 1-2 | NaBOB | 0.10% | 0.018% | 0.0458 |
| Example 1-3 | KBOB | 0.10% | 0.018% | 0.0459 |
| Example 1-4 | CsBOB | 0.10% | 0.018% | 0.0457 |
| Example 1-5 | Formula II-1 | 0.01% | 0.018% | 0.0460 |
| Example 1-6 | Formula II-1 | 0.10% | 0.018% | 0.0457 |
| Example 1-7 | Formula II-1 | 1.00% | 0.018% | 0.0452 |
| Example 1-8 | Formula II-1 | 3.00% | 0.018% | 0.0452 |
| Example 1-9 | Formula II-1 | 5.00% | 0.018% | 0.0454 |
| Example 1-10 | Formula III-1 | 0.10% | 0.018% | 0.0468 |
| Example 1-11 | Formula IV-1 | 0.10% | 0.018% | 0.0465 |
| Example 1-12 | Li₂C₂O₄ | 0.01% | 0.018% | 0.0469 |
| Example 1-13 | Formula V-1 | 0.10% | 0.018% | 0.0466 |
| Example 1-14 | Formula V-4 | 0.10% | 0.018% | 0.0465 |
| Example 1-15 | Formula V-7 | 0.10% | 0.018% | 0.0467 |
| Example 1-16 | Formula II-1 | 0.10% | 0.001% | 0.0469 |
| Example 1-17 | Formula II-1 | 0.10% | 0.010% | 0.0466 |
| Example 1-18 | Formula II-1 | 0.10% | 0.050% | 0.0450 |
| Example 1-19 | Formula II-1 | 0.10% | 0.100% | 0.0449 |
| Example 1-20 | Formula II-1 | 0.10% | 0.500% | 0.0449 |

Note:
“—” in Table 1 indicates the absence of the corresponding parameter.

In Comparative Example 1-1, the electrolyte contains no oxalate-based compound, and the negative electrode current collector contains no Cr. In Comparative Example 1-2, the negative electrode current collector contains a certain amount of Cr, but the electrolyte contains no oxalate-based compound. In Comparative Example 1-3, the electrolyte contains a certain amount of oxalate-based compound, but the negative electrode current collector contains no Cr. In Comparative Example 1-4, the electrolyte contains no oxalate-based compound, and the negative electrode current collector contains excessive Cr. These lithium-ion batteries exhibit high self-discharge and cannot meet practical requirements.

As shown in Examples 1-1 to 1-20, when the electrolyte contains 0.01% to 5% of an oxalate-based compound and the negative electrode current collector contains 0.001% to 0.5% of chromium, the self-discharge of the lithium-ion battery can be significantly reduced.

Since the cost of oxalate-based compounds is higher than other substances in the electrolyte, considering both the self-discharge performance and cost of the lithium-ion battery, when the percentage of the oxalate-based compound in the electrolyte is in the range of 0.01% to 3%, the improvement in self-discharge is more pronounced, and the cost is reasonable. When the percentage of the oxalate-based compound in the electrolyte is in the range of 0.01% to 1%, the improvement in self-discharge is particularly significant, and the cost is even more reasonable.

Since an increase in chromium percentage increases the cost of the negative electrode current collector, considering both the self-discharge performance and cost of the lithium-ion battery, when chromium percentage in the negative electrode current collector is from 0.001% to 0.1%, the improvement in self-discharge is more pronounced, and the cost is reasonable. When the chromium percentage in the negative electrode current collector is from 0.001% to 0.05%, the improvement in self-discharge is particularly significant, and the cost is even more reasonable.

Table 2 shows the effects of cyclic esters and linear esters and their percentages in the electrolyte on the self-discharge and low-temperature discharge performance of the lithium-ion battery. Except for the parameters listed in Table 2, the settings of Examples 2-1 to 2-11 are consistent with those of Example 1-6.

TABLE 2

| | | Linear | S1/ | K | |
|---|---|---|---|---|---|
| | Cyclic ester | ester | S2 | (mV/h) | D |
| Example 1-6 | 20% EC + 25% | 20% DEC + | 1.13 | 0.0457 | 79.1% |
| | PC | 20% EMC | | | |
| Example 2-1 | 25% EC | 60% EMC | 0.42 | 0.0455 | 85.5% |
| Example 2-2 | 15% EC | 75% DEC | 0.2 | 0.0458 | 81.3% |
| Example 2-3 | 20% EC + 20% | 40% EMC | 1 | 0.0450 | 85.8% |
| | PC | | | | |
| Example 2-4 | 20% EC + 10% | 20% DEC + | 0.5 | 0.0459 | 87.2% |
| | PC | 20% EMC + | | | |
| | | 20% DMC | | | |
| Example 2-5 | 20% EC + 10% | 20% DEC + | 0.5 | 0.0460 | 81.6% |
| | PC | 40% PP | | | |
| Example 2-6 | 20% EC + 10% | 20% DEC + | 0.5 | 0.0461 | 86.0% |
| | PC | 40% EP | | | |
| Example 2-7 | 20% EC + 10% | 20% DEC + | 0.5 | 0.0465 | 89.9% |
| | PC | 20% PP + | | | |
| | | 20% EA | | | |
| Example 2-8 | 20% EC + 10% | 20% DEC + | 0.5 | 0.0456 | 85.1% |
| | GBL | 40% EMC | | | |
| Example 2-9 | 20% PC + 10% | 20% DEC + | 0.5 | 0.0448 | 85.7% |
| | FEC | 40% EMC | | | |
| Example 2-10 | 20% GBL + | 20% DEC + | 0.5 | 0.0445 | 84.8% |
| | 10% FEC | 40% EMC | | | |
| Example 2-11 | 15% EC + 10% | 20% DEC + | 0.5 | 0.0446 | 85.5% |
| | PC + 5% FEC | 40% EMC | | | |

The results show that when the electrolyte further includes cyclic esters and linear esters with the ratio of the cyclic ester percentage (S1%) to the linear ester percentage (S2%), S1/S2, in the range of 0.2 to 1, the lithium-ion battery not only maintains low self-discharge but also achieves a low-temperature discharge capacity retention rate of at least 80%. This is because, within this range, the mixed solvent forms a suitable coordination relationship with the electrolyte salt (for example, LiPF₆), existing in the form of ion clusters, which weakens the redox reaction activity of individual solvents, helps reduce chemical self-discharge caused by side reactions, and maintains stable K values; at the same time, it ensures sufficient dissociation of the electrolyte salt and a relatively low overall viscosity of the electrolyte, enhancing the electrolyte conductivity, thereby improving the low-temperature discharge performance of the battery.

Table 3 shows the effects of additives in the electrolyte on the self-discharge and high-temperature storage performance of the lithium-ion battery. Except for the parameters listed in Table 3, the settings of Examples 3-1 to 3-10 are consistent with those of Example 1-6.

TABLE 3

| | | | | High-temperature |
|---|---|---|---|---|
| | Additive | | K | storage thickness |
| | Type | Percentage | (mV/h) | expansion rate |
| Example 1-6 | — | — | 0.0457 | 25.10% |
| Example 3-1 | LiPO₂F₂ | 0.01% | 0.0381 | 23.80% |
| Example 3-2 | LiPO₂F₂ | 0.30% | 0.0377 | 20.90% |
| Example 3-3 | LiPO₂F₂ | 1.00% | 0.037 | 18.20% |
| Example 3-4 | DTD | 1.00% | 0.0375 | 18.50% |
| Example 3-5 | VC | 0.50% | 0.0371 | 18.10% |
| Example 3-6 | VC | 0.50% | 0.0366 | 15.20% |
| | PS | 1.00% | | |
| Example 3-7 | VC | 0.50% | 0.0362 | 13.60% |
| | PS | 4.50% | | |
| Example 3-8 | LiPO₂F₂ | 0.30% | 0.0365 | 14.70% |
| | DTD | 1.00% | | |
| Example 3-9 | LiPO₂F₂ | 0.30% | 0.036 | 14.30% |
| | DTD | 1.00% | | |
| | VC | 0.50% | | |
| Example 3-10 | LiPO₂F₂ | 0.30% | 0.0355 | 10.10% |
| | DTD | 1.00% | | |
| | VC | 0.50% | | |
| | PS | 2.00% | | |

Note:
“—” in Table 3 indicates the absence of the corresponding parameter.

The results show that when the electrolyte further contains 0.01 wt % to 5 wt % of additives (at least one of PS, DTD, LiPO₂F₂, and VC), the self-discharge of the lithium-ion battery can be further reduced, and the high-temperature storage thickness expansion rate of the lithium-ion battery is significantly reduced. This is mainly because the operating voltage range of lithium batteries generally exceeds the electrochemical window of the solvent in the electrolyte, and the solvent undergoes continuous side reactions at the electrode surface, causing chemical self-discharge. Adding a certain amount of additives to the electrolyte can form a protective layer on the electrode surface, further slowing down the side reactions of the solvent at the electrode surface, thereby improving the K value and reducing gas generation.

Throughout the specification, references to “embodiment”, “some embodiments”, “one embodiment”, “another example”, “example”, “specific example”, “or “some examples” mean that at least one embodiment or example of the present application includes the specific feature, structure, material, or characteristic described in that embodiment or example. Therefore, descriptions appearing in various places throughout the specification, such as “in some embodiments”, “in embodiments”, “in one embodiment”, “in another example”, “in one example”, “in a specific example”, “or “for example”, “do not necessarily refer to the same embodiment or example in the present application. Furthermore, the specific features, structures, materials, or characteristics described herein may be combined in any suitable manner in one or more embodiments or examples.

Although illustrative embodiments have been demonstrated and described, persons skilled in the art should understand that the foregoing embodiments should not be construed as any limitation on the present application, and that some embodiments may be changed, replaced, and modified without departing from the spirit, principle, and scope of the present application.

The above are only preferred embodiments of the present application and are not intended to limit the present application. Any modifications, equivalent substitutions, improvements, and the like, made within the spirit and principles of the present application shall be included within the scope of protection of the present application.

What is claimed is:

1. An electrochemical device comprising a negative electrode and an electrolyte; wherein:
the negative electrode comprises a negative electrode current collector and a negative electrode active material layer disposed on at least one surface of the negative electrode current collector; the negative electrode current collector containing chromium; wherein based on a mass of the negative electrode current collector, a mass percentage of chromium is in a range of 0.001% to 0.5%;
the electrolyte comprises an oxalate-based compound; wherein based on a mass of the electrolyte, a mass percentage of the oxalate-based compound is in a range of 0.01% to 5%; and
the oxalate-based compound comprises at least one of a compound of formula I, a compound of formula II, a compound of formula III, a compound of formula IV, or a compound of formula V: 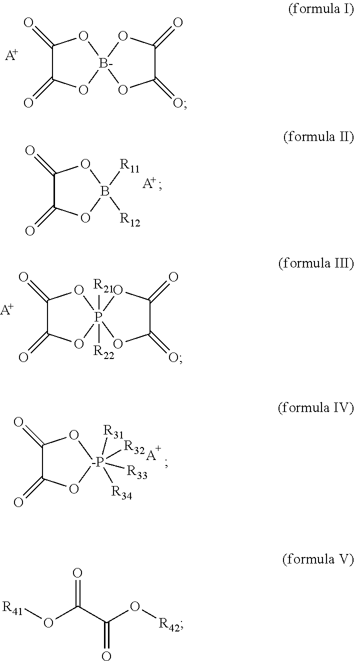
wherein:
each A⁺ is independently selected from Li⁺, Na⁺, K⁺, or Cs⁺;
R₁₁, R₁₂, R₂₁, R₂₂, R₃₁, R₃₂, R₃₃, and R₃₄ are each independently selected from halogen, unsubstituted or halogen-substituted C₁₋₄ alkyl, unsubstituted or halogen-substituted C₂₋₄ alkenyl, or unsubstituted or halogen-substituted C₂₋₄ alkynyl; and
R₄₁ and R₄₂ are each independently selected from H, Li, Na, K, Cs, NH₄, unsubstituted or halogen-substituted C₁₋₄ alkyl, unsubstituted or fluorine-substituted C₂-4 alkenyl, or unsubstituted or fluorine-substituted C₂₋₄ alkynyl, wherein R₄₁ and R₄₂ may optionally bond with atoms to which R₄₁ and R₄₂ are attached to form a ring.

2. The electrochemical device according to claim 1, wherein the electrochemical device satisfies at least one of the following conditions:
the oxalate-based compound comprises the compound of formula I; and the compound of formula I comprises at least one of the following compounds: lithium bis(oxalato) borate, sodium bis(oxalato) borate, cesium bis(oxalato) borate, or potassium bis(oxalato) borate;
the oxalate-based compound comprises the compound of formula II; and the compound of formula II comprises at least one of the following compounds: 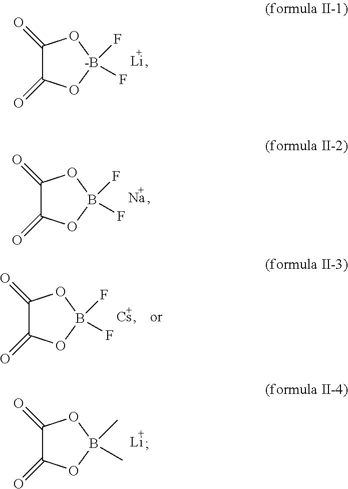
the oxalate-based compound comprises the compound of formula III; and the compound of formula III comprises at least one of the following compounds: 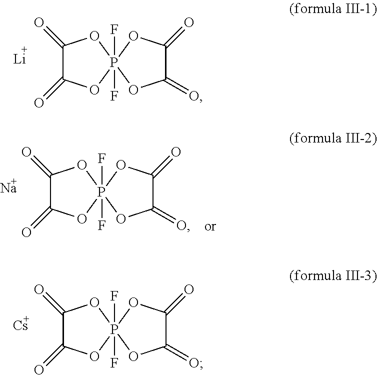
the oxalate-based compound comprises the compound of formula IV; and the compound of formula IV comprises at least one of the following compounds: 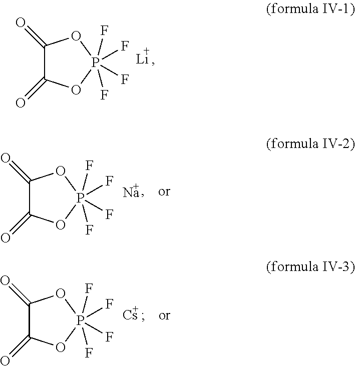
the oxalate-based compound comprises the compound of formula V; and the compound of formula V comprises at least one of the following compounds:
H₂C₂O₄, Li₂C₂O₄, Na₂C₂O₄, K₂C₂O₄, CS₂C₂O₄, NH₄C₂O₄, CH₃C₂O₄Li,

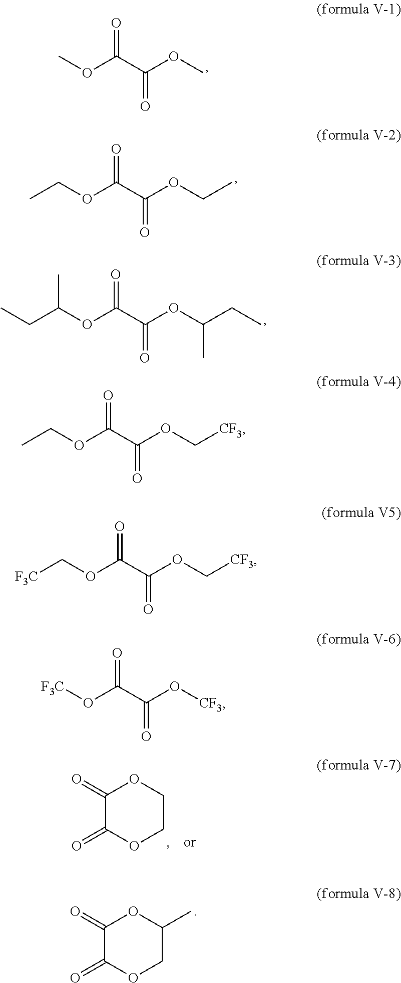

3. The electrochemical device according to claim 1, wherein based on the mass of the electrolyte, the mass percentage of the oxalate-based compound is in a range of 0.01% to 3%.

4. The electrochemical device according to claim 1, wherein based on the mass of the electrolyte, the mass percentage of the oxalate-based compound is in a range of 0.01% to 1%.

5. The electrochemical device according to claim 1, wherein based on the mass of the negative electrode current collector, the mass percentage of the chromium is in a range of 0.001% to 0.1%.

6. The electrochemical device according to claim 1, wherein based on the mass of the negative electrode current collector, the mass percentage of the chromium is in a range of 0.001% to 0.05%.

7. The electrochemical device according to claim 1, wherein the negative electrode current collector is a copper foil.

8. The electrochemical device according to claim 1, wherein the electrolyte further comprises a cyclic ester and a linear ester; the cyclic ester comprising at least one of ethylene carbonate, propylene carbonate, γ-butyrolactone, or fluoroethylene carbonate;
and the linear ester comprising at least one of diethyl carbonate, ethyl methyl carbonate, dimethyl carbonate, ethyl acetate, ethyl propionate, or propyl propionate; and
based on the mass of the electrolyte, a mass percentage of the cyclic ester is S1%, and a mass percentage of the linear ester is S2%, wherein S1/S2 is in a range of 0.2 to 1.

9. The electrochemical device according to claim 8, wherein S1 is in a range of 15 to 50.

10. The electrochemical device according to claim 1, wherein the electrolyte further comprises an additive; the additive being selected from at least one of 1,3-propane sultone, ethylene sulfate, lithium difluorophosphate, or vinylene carbonate; wherein based on the mass of the electrolyte, a mass percentage of the additive is in a range of 0.01 wt % to 5 wt %.

11. An electronic device comprising an electrochemical device, the electrochemical device comprises a negative electrode and an electrolyte; wherein,
the negative electrode comprises a negative electrode current collector and a negative electrode active material layer disposed on at least one surface of the negative electrode current collector; the negative electrode current collector containing chromium; wherein based on a mass of the negative electrode current collector, a mass percentage of chromium is in a range of 0.001% to 0.5%;
the electrolyte comprises an oxalate-based compound; wherein based on a mass of the electrolyte, a mass percentage of the oxalate-based compound is in a range of 0.01% to 5%; and
the oxalate-based compound comprises at least one of a compound of formula I, a compound of formula II, a compound of formula III, a compound of formula IV, or a compound of formula V: 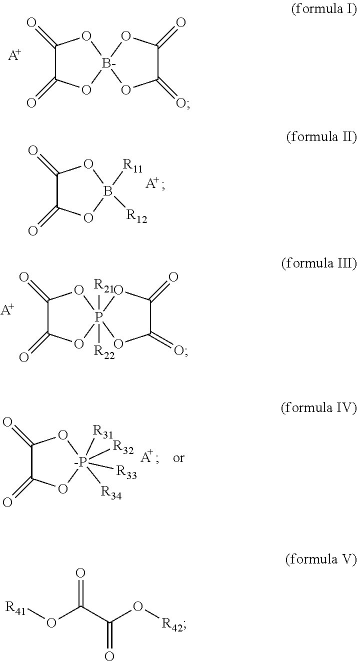
wherein:
each A⁺ is independently selected from Lit, Na⁺, K⁺, or Cs⁺;
R₁₁, R₁₂, R₂₁, R₂₂, R₃₁, R₃₂, R₃₃, and R₃₄ are each independently selected from halogen, unsubstituted or halogen-substituted C₁₋₄ alkyl, unsubstituted or halogen-substituted C₂₋₄ alkenyl, or unsubstituted or halogen-substituted C₂₋₄ alkynyl; and
R₄₁ and R₄₂ are each independently selected from H, Li, Na, K, Cs, NH₄, unsubstituted or halogen-substituted C₁₋₄ alkyl, unsubstituted or fluorine-substituted C₂-4 alkenyl, or unsubstituted or fluorine-substituted C₂₋₄ alkynyl, wherein R₄₁ and R₄₂ may optionally bond with atoms to which R₄₁ and R₄₂ are attached to form a ring.

12. The electronic device according to claim 11, wherein the electrochemical device satisfies at least one of the following conditions:
the oxalate-based compound comprises the compound of formula I; and the compound of formula I comprises at least one of the following compounds: lithium bis(oxalato) borate, sodium bis(oxalato) borate, cesium bis(oxalato) borate, or potassium bis(oxalato) borate;
the oxalate-based compound comprises the compound of formula II; and the compound of formula II comprises at least one of the following compounds: 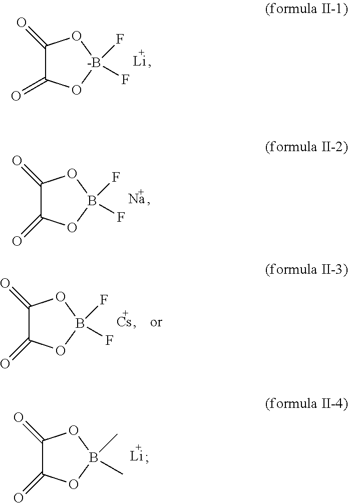
the oxalate-based compound comprises the compound of formula III; and the compound of formula III comprises at least one of the following compounds: 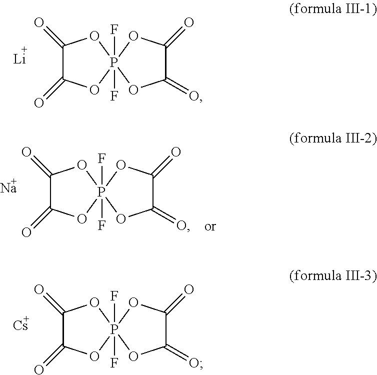
the oxalate-based compound comprises the compound of formula IV; and the compound of formula IV comprises at least one of the following compounds: 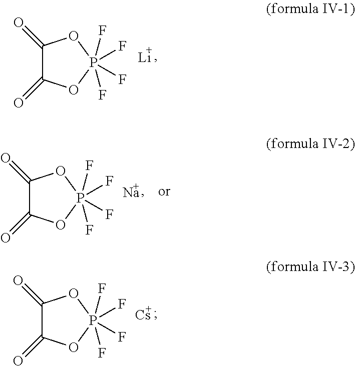
or
the oxalate-based compound comprises the compound of formula V; and the compound of formula V comprises at least one of the following compounds:
H₂C₂O₄, Li₂C₂O₄, Na₂C₂O₄, K₂C₂O₄, CS₂C₂O₄, NH₄C₂O₄, CH₃C₂O₄Li,

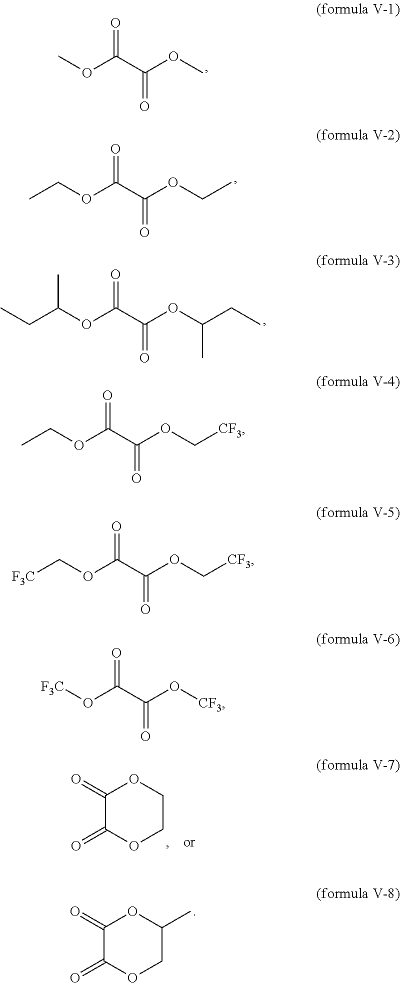

13. The electronic device according to claim 11, wherein based on the mass of the electrolyte, the mass percentage of the oxalate-based compound is in a range of 0.01% to 3%.

14. The electronic device according to claim 11, wherein based on the mass of the electrolyte, the mass percentage of the oxalate-based compound is in a range of 0.01% to 1%.

15. The electronic device according to claim 11, wherein based on the mass of the negative electrode current collector, the mass percentage of chromium is in a range of 0.001% to 0.1%.

16. The electronic device according to claim 11, wherein based on the mass of the negative electrode current collector, the mass percentage of chromium is in a range of 0.001% to 0.05%.

17. The electronic device according to claim 11, wherein the negative electrode current collector is copper foil.

18. The electronic device according to claim 11, wherein the electrolyte further comprises a cyclic ester and a linear ester; the cyclic ester comprising at least one of ethylene carbonate, propylene carbonate, γ-butyrolactone, or fluoroethylene carbonate;
and the linear ester comprising at least one of diethyl carbonate, ethyl methyl carbonate, dimethyl carbonate, ethyl acetate, ethyl propionate, or propyl propionate; and
based on the mass of the electrolyte, a mass percentage of the cyclic ester is S1%, and a mass percentage of the linear ester is S2%, wherein S1/S2 is in a range of 0.2 to 1.

19. The electronic device according to claim 18, wherein S1 is in a range of 15 to 50.

20. The electronic device according to claim 11, wherein the electrolyte further comprises an additive; the additive being selected from at least one of 1,3-propane sultone, ethylene sulfate, lithium difluorophosphate, or vinylene carbonate, wherein based on the mass of the electrolyte, a mass percentage of the additive is in a range of 0.01 wt % to 5 wt %.
